(19) United States
(12) Patent Application Publication
(10) Pub. No.: US 2025/0231778 A1
(43) Pub. Date: Jul. 17, 2025

(54) SYSTEMS AND METHODS FOR GENERATING CONTEXT-BASED INPUT INTERFACES

(71) Applicant: VIZIO, INC., Irvine, CA (US)

(72) Inventor: Anirudh Lath, Farmers Branch, TX (US)

(73) Assignee: VIZIO, INC., Irvine, CA (US)

(21) Appl. No.: 18/894,456

(22) Filed: Sep. 24, 2024

Related U.S. Application Data
(60) Provisional application No. 63/620,554, filed on Jan. 12, 2024.

(51) Int. Cl. G06F 9/451; G06F 3/04842; H04N 21/41

(52) U.S. Cl. CPC G06F 9/451; G06F 3/04842; H04N 21/41265

(57) ABSTRACT

A context-based input interface from a first interface can be presented to increase a rate and accuracy of providing input to the first interface. A computing device may receive user input via a first interface. In response, the computing device may define a context using one or more characteristics of the first input interface. The computing device may then generate a second input interface configured to execute a function that modify the first input interface. The function can be selected based on the context. The computing device may receive a selection of a particular function via the second interface and implement the function to modify the first input interface. The computing device may terminate the second interface upon executing the function and return to the first interface.

### CROSS-REFERENCE TO RELATED APPLICATIONS

The present patent application claims the benefit of priority to U.S. Provisional Patent Application No. 63/620,554 filed Jan. 12, 2024, which is incorporated herein by reference in its entirety for all purposes.

### TECHNICAL FIELD

This disclosure relates generally to input interfaces, and more particularly to dynamically generating context-based input interfaces.

### BACKGROUND

Some processing devices may include limited means for receiving user input that may prevent the efficient use some functions of the processing device. For instance, televisions are provided a remote controller (also referred to herein as a controller) that has a limited set of buttons for controlling the operations of the television such as volume, channel, etc. Most controllers do not include a full keyboard, which may limit the ability of a user to provide textual input (e.g., such as a movie title within a search window, etc.). Some processing devices may provide digital keyboards to allow the entry of individual characters, but digital keyboards increase the complexity of entering text and increase the likelihood of introducing error. For example, to type the word “hello” on a physical interface keyboard, it will take the user exactly 5 key presses, while on a digital keyboard, it could take as many as 17 key presses to type the same word. In addition, the quantity of key presses may increase substantially when the user presses the wrong key or the digital keyboard fails to register a key press. For example, there may be additional key presses to navigate to a backspace and even more key presses to navigate to the correct key.

### SUMMARY

The Methods described herein may be configured to dynamically generating context-based input interfaces. The methods can include receiving, via a first input interface, a user input; defining, in response to receiving the user input, a context using one or more characteristics of the first input interface; generating a second input interface configured to execute one or more functions that modify the first input interface, wherein the one or more functions are selected based on the context; presenting the second input interface; receiving, via the second input interface, a selection of a particular function from the one or more functions; and modifying the first input interfaces by executing the particular function, wherein upon executing the function, the second input interface is terminated

The systems described herein may be configured for dynamically generating context-based input interfaces. The systems may include one or more processors and a non-transitory computer-readable medium storing instructions that, when executed by the one or more processors, cause the one or more processors to perform any of the methods as previously described.

The non-transitory computer-readable media described herein may be configured to store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example computing device configured to generate context-based input interfaces for improved operation of media devices according to aspects of the present disclosure.

FIG. 2 illustrates an example representation of a digital keyboard interface on a television enabling alphanumeric input according to aspects of the present disclosure.

FIG. 3 illustrates an example physical interface of a remote controller of a media device according to aspects of the present disclosure.

FIG. 4 illustrates an example digital keyboard interface according to aspects of the present disclosure.

FIG. 5 illustrates an example of providing input through a digital keyboard interface according to aspects of the present disclosure.

FIG. 6 illustrates an example transition from a digital keyboard interface to a context-based input interface according to aspects of the present disclosure.

FIG. 7 illustrates an example navigation of a context-based input interface according to aspects of the present disclosure.

FIG. 8 illustrates an example context-based input interfaces according to aspects of the present disclosure.

FIG. 9 illustrates a flowchart of an example process for generating context-based input interfaces according to aspects of the present disclosure.

FIG. 10 illustrates an example computing device architecture of an example computing device that can implement the various techniques described herein according to aspects of the present disclosure.

### DETAILED DESCRIPTION

Systems and methods are described herein for dynamically generating context-based input interfaces. Input interfaces may be defined based in part on the input that can be provided by a particular input device. An input interface configured to receive alphanumeric characters from an input device that lacks a full keyboard, for example, may enable another way for the input device to provide alphanumeric characters such as selectable objects representing alphanumeric characters. Context-based interfaces may be dynamically generated interfaces that with selectable objects and/or functions that are determined based on previously presented interfaces and/or received input. Context-based interfaces can receive input that is not expressly provided by input devices (as in the previous example), define an input from input devices that is based on fewer interactions with the input device, increase an accuracy of input from input devices, and increase a rate that input can be provide by input devices.

For example, an input device lacking a keyboard may be operated to provide a particular input to a media device (e.g., such as alphanumeric text) through an input interface. Pressing a particular button of the input device may cause a user interface to be presented by the media device over the input interface. The user interface may include one or more functions selected based on a selected portion of an input interface of the media device before the user interface is presented and/or input previously provided to the input interface (e.g., previous characters, numbers, words, phrases, etc.). The input device may provide input to select a function of the one or more functions to execute. In some examples, the one or more functions may be configured to modify the input interface, provide particular input to the input interface, etc. By dynamically selecting and presenting the one or more functions through the user interface over the input interface, input can be provided more efficiently to the input interface requiring less interaction with the input device (e.g., fewer button presses, etc.).

Devices may be paired with an input device configured for a particular device. For example, a television may include a remote controller designed for the specific television or brand of televisions. In some instances, the input devices may include a simplified design (e.g., smaller form factor, fewer buttons, etc.) to improve user operability. Improving user operability may shift the complexity of providing input to the input interface the device. For example, an input device may include a simple set of controls (e.g., buttons, touch interfaces, etc.) for navigation including an “up” button, “down” button, “left” button, “right” button, and “select” button. The input device may lack the functionality to provide complex inputs such a keyboard or keypad for providing alphanumeric text. Instead, the device may include an input interface that includes a representation of a keyboard or keypad. The “up”, “down”, “left”, and “right” buttons may be operated to select a particular character or number and the “select” button may be operated to provide the selected character or number as input. The representation of the keyboard may include additional components such as to enable entering device specific input, entering symbols, executing input related functions (such as, but not limited to, accepting or submitting the currently provided input, removing a portion of the currently provided input such as the last character, removing the entire currently provided input, adding preconfigured input such as domain names for email address or frequently provided input, providing frequently provided input based previously provided input, providing frequently provided input based on the interface or context of the input interface, combinations thereof, or the like).

Context-based input interfaces can be generated to improve processing input from input devices with limited controls. The context-based input interface may be accessed via an input interface of the media device. For example, a context-based input interface may be generated and presented on top of the input interface, on the same screen as the input interface, in place of the input interface, etc. The context-based input interface may be generated based on a currently selected portion of the input interface, previous input provided to the input interface (e.g., such as but not limited to, an identification of a user operating the input device, previously received one or more characters, one or more words, etc.; previously received commands such as submitting input, removing one or more characters, removing the entire input, etc.; combinations thereof, or the like), combinations thereof, or the like. The context-based input interface can be triggered when the media device is presented an input interface by actuating a particular button of an input device or actuating a particular button of the input device for a predetermined time interval. The particular representation of the context-based input interface may be based on the input interface from which the context-based input interface is accessed. For example, the context-based input interface accessed from a representation of a keyboard may include a first representation with one or more selectable functions selected based on the representation of the keyboard. The context-based input interface accessed from a media selection interface may include a second, different representation with one or more different selectable functions, etc.

In some examples, a context-based input interface may include one or more selectable functions that may execute to modify the input interface increasing the efficiency of user interaction with the input interface. The one or more functions may be selected so as to reduce a quantity of buttons that may be actuated by the user to provide input to the input interface. For example, the context-based input interface may enable a quick access to text-editing functions such as, but not limited to, backspace (e.g., to delete the character to the left of a selected position within the text input), space (e.g., to provide a space character at a selected position of the text input), delete (e.g., to delete the character to the right of a selected position within the text input), enter (e.g., to submit the current text input via the input interface), delete all (e.g., to remove the text input), return (e.g., to return to a previous interface from the input interface), view (e.g., to reveal obscured characters such as those from a password entry), input special (e.g., add preselected text such as common domain names for email addresses, frequently input text, etc.), predictive input (e.g., a predicted character or word likely to be added after a previous character or word input, predicted other input, etc.), combinations thereof, or the like.

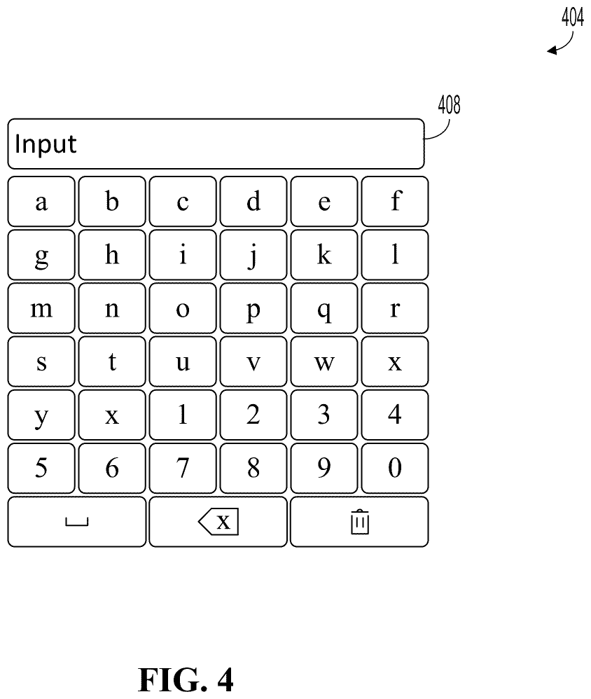

In some instances, in addition to or in place of the text-editing functions, the context-based input interface may include quickly selectable entries from the input interface. For instance, an input interface including a representation of a keyboard may be usable to generate an input text string. An input device may be used to select individual characters from the representation of the keyboard. A context-based input interface may include one or more selectable characters (and/or text-editing functions) from the input interface determined based on a distance from the currently selected character of the input interface from which the context-based input interface is accessed. For example, a representation of a keyboard may represent characters in a grid pattern that is 6 by 7 with a first row including the characters a-f, the second row including the characters g-l, etc. (as depicted in FIG. 4). The top, bottom, left-most, or right-most portion of the representation may include text-editing functions. The input device may be usable to select a particular character such as the letter ‘h’ when beginning to type the word “hello”. A context-based input interface may be accessed from the representation of the character ‘h’. The context-based input interface may include one or more characters or text-editing functions selected based on a distance from the character ‘h’ to reduce a quantity of buttons that would be actuated by the user when selecting characters (or text-editing functions) of the input interface. For example, upon accessing the context-based input interface, the context-based input interface may include a representation of a backspace function, a delete function, a remove function, and a space function based on the text-editing options appear on the bottom of the representation of the keyboard and thus furthest from the character ‘h’. Additionally, or alternatively, the context-based input interface may include the character ‘e’ as being a predicted character to follow the character ‘h’.

The context-based input interface can be accessed with a single button actuation and a function or input can be selected from the context-based input interface for a second button actuation (or by de-actuating the button by removing pressure applied to the button after the single button actuation). The context-based input interface enables entering text or editing text with one or two actuations of a button that would ordinarily necessitate multiple actuations to navigated to a particular character followed by an actuation to select the character to add to the current input.

The media device may define the context-based input interface when input associated with the context-based input interface is received from an input device. The media device may define a set of options to be presented by the context-based input interface. The set of options may include one or more selectable input and/or more text-editing input that can be included in the context-based input interface based on the input interface from which the context-based input interface is accessed. In some instances, the media device may then filter the set of options based on contextual information associated with the input interface from which the context-based input interface is accessed such as, but not limited to, an interface type associated with the input interface from which the context-based input interface is accessed, an input type acceptable by the input interface from which the context-based input interface is accessed, user information, previous input received by the input interface, historical input provided by the user, a position of a cursor or a current location of the input interface when the context-based input interface is accessed, combinations thereof, or the like. The media device may then select the first one or more options from the remaining set of options to include in the context-based input interface. In other instances, the media device may represent the set of options as a hierarchy based on a category or value assigned to each option. The media device may order the set of options based on the hierarchy and select the top one or more context-based input interface (e.g., the one or more options that are positioned highest or first in the hierarchy, etc.) to include in the context-based input interface.

In still yet other instances, the media device may use a machine-learning model to select the one or more options to include in the context-based input interface. The machine-learning model may be a configured to predict one or more options that are likely to be selected by the user based on the current state of the input interface. The machine-learning model may also be configured to output a confidence score for each prediction indicative of the likelihood that the user will select that option. Examples of machine-learning models that may be trained to predict the one or more options include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The machine-learning model may be trained using training data including historical interactions with the input interface, a current state of input interface when the contextual interface is activated, and/or any of the other forementioned contextual information. In some examples, the training data may be associated with a particular to tailor the trained machine-learning model to the particular user. In other examples, the training data may be associated with a particular class of users (e.g., users sharing one or more characteristics such as demographic information, interests, etc.) to tailor the trained machine-learning model to the particular class of users. In other instances, training data may be associated with general users. In other examples, the training data may initially be associated with general users when there is insufficient training data associated with the particular user or the particular class of users. As more training data associated with the particular user or the particular class of users is recorded, the machine-learning model may be retrained using the training data associated with the particular user or the particular class of users. As a result, the machine-learning model may be initially trained for general users and become tailored to the particular user or the particular class of users over time.

The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

In still yet other instances, the media device may preconfigure the context-based input interface based on the input interface from which the context-based input interface is accessed. In those instances, the context-based input interface may be statically defined such that each time the context-based input interface is accessed from a same context (e.g., input interface, etc.), the context-based input interface may include a same one or more options.

In an illustrative example, a computing device (e.g., a processing device that includes a display) may receive user input via a first input interface. The input may be received via an input device such as a mobile device, remote controller, or processing device in communication with the computing device. The first input interface may include a representation of particular input device enabling input from input devices that lack the controls that may be included by the particular device. For example, the first input interface may include a representation of a keyboard with each key of the keyboard being selectable using the input device to provide alphanumeric input. The first input interface may include a representation of other input devices (e.g., such as a keypad, joystick, touch interface, gamepad, or any other device configured to provide input). For example, the computing device may be operated by an input device (e.g., connected via a wired cable or a wireless communication protocol such as, but not limited to, infrared, Bluetooth, Wi-Fi, Zigbec, or other wireless protocol). The input device may include one or more buttons that can be physically actuated or touch pads that can be manipulated by a user to provide input. Since the input device may lack certain controls (e.g., such as a keypad, keyboard, joystick, particular buttons, etc.), the computing device may generate the first input interface with a representation of a particular input device that includes controls missing from the input device.

The computing device may define a context using one or more characteristics of the first input interface in response to receiving the user input. A context may be a representation of a state of the first input interface, the computing device, and/or the user operating the computing device. For example, the current state of the first input interface may include, but is not limited to, an identification of the first input interface, an identification of an input type accepted by the first input interface (e.g., characters; numbers; alphanumeric text; particular text such as a username, password, email address, title, code, etc.; image; audio segment; video; etc.), an input already received at the first input interface since the first input interface was presented, a location of a cursor relative to the first input interface, a current button or control of the first input interface that is selected, an identification of what triggered the generation of the first input interface (e.g., how the first input interface was selected, what was being presented by the computing device when the first input interface was selected for generation, etc.), combinations thereof, or the like. The current state of the computing device may include, but is not limited to, an identification of the processing capabilities of the computing device (e.g., available processing resources, network resources, etc.), network information such as an Internet Protocol (IP) address, Media Access Control (MAC) address, etc.), an identification of media that is available for presentation by the computing device (e.g., an identification of content that is currently being presented on channels accessible to the computing device), an identification of media that can be presented by the computing device (e.g., text, audio, and/or video; file types that can be presented; video resolutions that are supported; combinations thereof, or the like), media presented by the computing device when the first input interface was generated, an interface from which the first input interface was generated, devices connected to the computing device such as streaming devices or game consoles, combinations thereof, or the like. The current state of the user may include, but is not limited to, an identification of the user, historical interactions with the computing device (e.g., search history, media viewed, channels viewed, etc.), historical interactions with devices connected to the computing device, combinations thereof, or the like.

The computing device may generate a second input interface. In some instances, the second input interface may be generated based on input from the input device such as actuating a button, actuating a button for a predetermined time interval (e.g., pressing a button down for the predetermined time interval), pressing a sequence of buttons, etc.). In other instances, the second input interface may be generated based on the context (e.g., the current location of the cursor or selected button or control of the first input interface, a current input of the first input interface, etc.). The second input interface may include an identification of one or more functions that can be selected using the input device via the second input interface. The one or more functions may be executed to modify the first input interface. The one or more functions may be selected based on the context. In some examples, the one or more functions may be editing functions configured to add and/or remove a current input provided to the first input interface such as, but not limited to, “backspace”, “delete”, “remove”, “view”, “space”, and/or the like. In some examples, the one or more functions may provide an input to the current input provided to the first input interface such as a symbol, character, number, or the like that is distant from a currently selected button or control of the first input interface. For example, the input device may be operated to select particular characters to input alphanumeric text using basic arrows (e.g., up, down, left, and right). The second input interface may be selected when a particular character is selected and provide options that can be selected to add input to the current input of the first input interface such as a space, backspace, a character or symbol that may be positioned far from the particular character (e.g., such that selection via the first input interface would require a quantity of button actuation that is greater than a threshold, etc.).

The one or more functions may be selected based on the context to generate a customized second input interface for a user that may increase a rate and/or accuracy in which input can be provided to the first input interface. The one or more functions may be selected based on, for example, a previous interface from which the first input interface is generated, a current input to the first input interface (e.g., input provided by the input device, etc.), a location of a cursor or a currently selected button or control of the first input interface when the second input interface was generated, etc.

The computing device may then present the second input interface. The second input interface may be presented over the first input interface, next to the first input interface (e.g., at any position that is on the same screen as the first input interface), in place of the first input interface, or the like. For example, the first input interface may be become deemphasized (e.g., placed in the background, minimized, reduced in size, presented as transparent or translucent, rendered in different colors, combinations thereof, or the like) and the second input interface may be presented over the first input interface. Alternatively, an animation may be presented transitions the first interface or the portion of the first interface that is highlighted into the second input interface.

In some instance, the second input interface may include a circle representing directional controls of the input device with icons represent the one or more functions positioned around the circle. The input device may be operated to highlight a function of the one or more functions. One or more buttons or a touch interface of the input device may be operated to select a particular function. The representation of the second input interface may be based on the first input interface and/or the quantity of functions of the one or more functions. For instance, if the one or more functions include eight or fewer functions, then the second input interface may include circular representing the directional controls of the input device. If the one or more functions include more than eight functions, then the second input interface may include a different representation such as a grid, or other representation in which the input device may be operated to select a function of the one or more functions with a single interaction with the input device.

The computing device may receive a selection of a particular function from the one or more functions via the second input interface. The selection may be performed by actuating a button or operating a touch interface of the input device. If the second input interface is generated based on actuating a button of the input device for a predetermined time interval, the function may be highlighted while the button is actuated (e.g., the button is be depressed) and selected by de-actuating the button (e.g., removing pressure from the button).

The second input interface may be terminated upon selection of the function. Alternatively, the second input interface may be terminated upon execution of the selected function. Upon termination of the second input interface, the computing device may return to the first input interface (if not already shown) or return the first input interface to prominence (if deemphasized in favor of the second input interface).

The computing device may modify the first input interface by executing the particular function. The input device may be operated to generate a new second input interface. Since the context may have changed since the previous generation of the second input interface, the new second input interface may include a different representation and/or different one or more functions that may be selected by the input device.

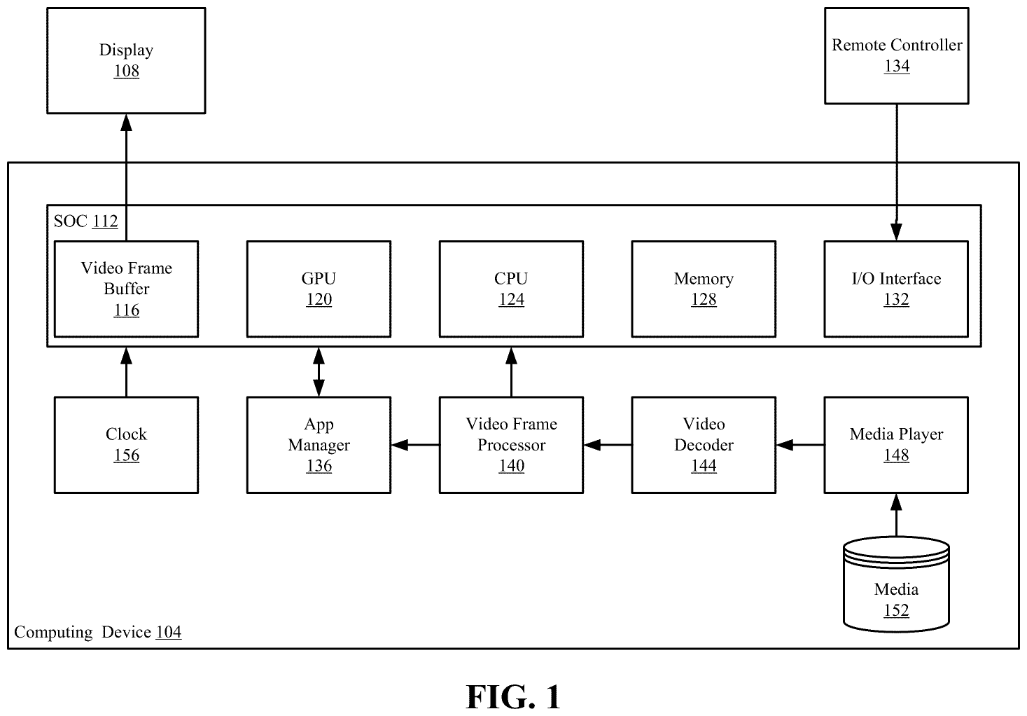

FIG. 1 illustrates a block diagram of an example computing device configured to generate context-based input interfaces for improved operation of media devices according to aspects of the present disclosure. Computing device 104 may include one or processing components (e.g., system-on-a-chip, central processing units, application-specific integrated circuits, field programmable gate arrays, and/or the like), memories (e.g., volatile and non-volatile memories, databases, etc.), network processors (e.g., including Wi-Fi transceivers, Bluetooth transceivers, and/or other transceivers, etc.), and one or more sensors (e.g., cameras, microphones, optical sensors, etc.).

Computing device 104 may be configured to present media to one or more users using display 108 and/or one or more wireless devices connected via a network processor (e.g., such as other display devices, mobile devices, tablets, and/or the like). Computing device 104 may retrieve the media from media database 152 (or alternatively receiving media from one or more broadcast sources, a remote source via a network processor, an external device, etc.). The media may be loaded by media player 148, which may process the media based on the container of the video (e.g., MPEG-4, QuickTime Movie, Wavefile Audio File Format, Audio Video Interleave, etc.). Media player 148 may pass the media to video decoder 144, which decodes the video into a sequence of video frames that can be displayed by display 108. The sequence of video frames may be passed to video frame processor 140 in preparation for display. Alternatively, media may be generated by an interactive service operating within app manager 136. App manager 136 may pass the sequence of frames generated by the interactive service to video frame processor 140.

The sequence of video frames may be passed to system-on-a-chip (SOC) 112. SOC 112 may include processing components configured to enable the presentation of the sequence of video components and/or audio components. SOC 112 may include central processing unit (CPU) 124, graphics processing unit (GPU) 120, memory 128 (e.g., volatile memories such as random-access memory or read-only memory, non-volatile memory (e.g., such as magnetic, flash, etc.), input/output interfaces 132, and video frame buffer 116.

SOC 112 may identify media segments being presented as well as media segments that are currently being presented by other channels accessible to SOC 112. SOC 112 may identify media segments by receiving scheduling data or metadata over the channel or the Internet (e.g., for streaming content, etc.), receiving scheduling data or metadata from a content provider (e.g., cable or satellite provider, content delivery network, etc.), and/or receiving scheduling data or metadata from one or more other sources.

Alternatively, or additionally, SOC 12 may identify media segments based on pixel data or audio data received of the media segment. SOC 112 may generate a cue from one or more video fames stored in video frame buffer 116 prior to or as the one or more video frames are presented by display 108. A cuc may be generated from one or more pixel arrays (also referred to as a pixel patch) of a video frame. A pixel patch can be any arbitrary shape or pattern such as (but not limited to) a y×z pixel array, including y pixels horizontally by z pixels vertically from the video frame. A pixel can include color values, such as a red, a green, and a blue value and intensity values. The color values for a pixel can be represented by an eight-bit binary value for each color. Other suitable color values that can be used to represent colors of a pixel include luma and chroma (Y, Cb, Cr, also called YUV) values or any other suitable color values.

SOC 112 may derive a mean value for each cue. The mean value may be a 4-bit data record representative of the cue. The display device may generate the cue by aggregating the average value for each pixel patch and adding a timestamp that corresponds to the frame from which the pixel patches were obtained. The timestamp may correspond to epoch time (e.g., which may represent the total elapsed time in fractions of a second since midnight, Jan. 1, 1970), a predetermined start time, an offset time (e.g., from the start of a media being presented or when the display device was powered on, etc.), or the like. The cue may also include metadata, which can include any information about media being presented, such as a program identifier, a program time, a program length, or any other information.

In some examples, a cue may be derived from any number of pixels patches obtained from a single video frame. Increasing the quantity of pixel patches included in a cue increases the data size of the cue, which may increase the processing load of the display device and the processing load of one or more cloud networks that may operate to identify content. For example, a cue derived from 5 pixel patches may correspond to 600-bits of data (24-bits per pixel patch times 5 pixel patches) not including the timestamp and any metadata. Increasing the quantity of video patches obtained from a video frame may increase the accuracy of boundary detection and content identification at the expense of increasing the processing load. Decreasing the quantity of video patches obtained from a video frame may decrease the accuracy of boundary detection and content identification while also decreasing the processing load of the display device. The display device may dynamically determine whether to generate cues using more or less pixel patches based on a target accuracy and/or processing load of the display devices.

Unknown cues may be compared to known cues of known media stored in database 156 to identify the media segment corresponding to the unknown cue. Media device may use a distance algorithm (e.g., Euclidean, Cosine, Haversine, Minkowski, etc.) or other matching algorithm to identify a closest known cue to an unknown cue. If the distance is less than a threshold distance, SOC 112 may assign the identifier of the known cue to the unknown cue thereby identifying the media segment that the unknown cue was derived from. SOC 112 may retrieve additional information associated with identifier. Cue database 156 may be a component of computing device 104 (e.g., stored in memory 128 or other memory of computing device 104 (not shown)) or may be a remote component (as shown).

SOC 112 may store the identification of the media segments in a (local and/or remote) database. In some instances, SOC 112 may use the identification of the media segments to generate context-based input interfaces usable to improve the rate and accuracy of providing input to other input interfaces. The context-based input interfaces may include one or more inputs (e.g., characters, words, phrases, domains, symbols, images, media segments, etc.) and/or text-editing functions (e.g., “delete”, “backspace”, “remove”, “view”, etc.) selected based on a context of computing device 104 when the context-based input interface is generated such as, but limited, the availability of particular media segments that can be presented by computing device 104 (e.g., what is currently being broadcast over channels receivable by computing device 104, streaming services, the Internet, etc.). SOC 112 may also use the identification of the media segments for other purposes such as providing context-based search, context-based navigation, content substitution, retrieving additional information associated with media segments (e.g., such as development information, actor information, setting information, etc.), and/or the like.

Computing device 104 may be operated by an input device such as remote controller 134. The input device may have one or more controls such as, but not limited to, physical buttons that can be actuated (e.g., by applying pressure), touch interfaces (e.g., capacitive touch surfaces, etc.), joysticks, microphones (e.g., for voice controls), etc. The particular controls included in remote controller 134 may be based on the functionality of computing device 104. For instance, if computing device 104 is a television, then remote controller 134 may include controls to change channels, change volume, directional controls (e.g., an “up” button, a “down” button, a “left” button, a “right” button, etc.), etc. If computing device 104 is a processing device, remote controller 134 may include other buttons associated with the functions enabled by the processing device.

Remote controller 134 may communicate with computing device 104 through a wired or wireless communication protocol. For example, remote controller 134 may transmit communications over a universal serial bus or other wired connection, using light emission (e.g., such an infrared light emitting diode, or the like), using a radio connection (e.g., Wi-Fi, Bluetooth, Zigbee, Z-wave, etc.), combinations thereof, or the like. Remote controller 134 may communicate in one direction (e.g., from remote controller 134 to computing device 104) or communicate bidirectionally (e.g., from remote controller 134 to computing device 104 and from computing device 104 to remote controller 134).

SOC 112 may be configured to generate context-based input interfaces improve the rate and accuracy in which input can be provided by remote controller 134, SOC 112 may define a context of computing device 104 at a given instant in time. The context may correspond to a state of a current input interface (form which a context-based input interface may be generated), a state of computing device 104, information associated with a user of computing device 104, or the like. The state of the current input interface may include, but is not limited to an identification of the first input interface, an identification of an input type accepted by the first input interface (e.g., characters; numbers; alphanumeric text; particular text such as a username, password, email address, title, code, etc.; image; audio segment; video; etc.), an input already received at the first input interface since the first input interface was presented, a location of a cursor relative to the first input interface, a current button or control of the first input interface that is selected, an identification of what triggered the generation of the first input interface (e.g., how the first input interface was selected, what was being presented by computing device 104 when the first input interface was selected for generation, etc.), combinations thereof, or the like. The state of computing device 104 may include, but is not limited to, an identification of the processing capabilities of computing device 104 (e.g., available processing resources, network resources, etc.), network information such as an Internet Protocol (IP) address, Media Access Control (MAC) address, etc.), an identification of media that is available for presentation by computing device 104 (e.g., an identification of content that is currently being presented on channels accessible to computing device 104), an identification of media that can be presented computing device 104 (e.g., text, audio, and/or video; file types that can be presented; video resolutions that are supported; combinations thereof, or the like), media presented by computing device 104 when the first input interface was generated, an interface from which the first input interface was generated, devices connected to computing device 104 such as streaming devices or game consoles, combinations thereof, or the like. The state of the user may include, but is not limited to, an identification of the user, historical interactions with computing device 104 (e.g., search history, historical input provided to interfaces of computing device 104, demographic information, communication preferences, email or other address associated with the user, media viewed, channels viewed, etc.), historical interactions with devices connected to computing device 104, combinations thereof, or the like. SOC 112 may update the context when data associated with a context changes. For example, SOC 112 may update the context when an input interface is presented by computing device 104.

SOC 112 may use the current context to generate context-based input interfaces. A context-based input interface can be defined from any input interface of computing device 104 (e.g., any interface through which the user may provide input via remote controller 134, other input/output devices, or the like). In some instances, a context-based input interface may be defined based on the input interface from which the context-based input interface is generated (which may be referred to as the initial input interface). SOC 112 may define a set of options that include one or more functions such as text-editing functions, one or more inputs, and/or the like that can modify the initial input interface (e.g., by modifying the current input to the initial input interface, modifying functions of the initial input interface, etc.). SOC 112 may then order the set of options based on the context to identify one or more options that are most likely to be contextually relevant to the user providing input to the initial input interface. SOC 112 may select the first one or more options of the set of options (e.g., the options being the most likely to be contextually relevant) to be represented by the context-based input interface.

Alternatively, or additionally, SOC 112 may order the set of options based on a distance from a current location of the initial input interface to the option (if present on the initial input interface). For example, the initial input interface may include a representation of a keyboard as a grid of characters, numbers, and text-editing functions. The remote controller 134 may be used to select individual characters, numbers, and text-editing functions using direction buttons configured to move from one position on the grid to an adjacent position on the gird. Since the user may be forced to press the direction buttons many times to navigate to a particular character, number, or text-editing functions, SOC 112 may order the set of options based on a distance from a current highlighted location on the grid. The distance may be determined based on a quantity of buttons that would have to be actuated to navigate from a highlighted location of the initial input interface to a destination location of the initial input interface. For example, when the character “h” is highlighted, the text-editing functions (which are usually located at the outer portions of the grid) may be further away than a threshold distance. SOC 112 may order the set of options so that the text-editing functions appear first so that the text-editing functions are more likely to be included in a context-based input interface.

Alternatively, or additionally, SOC 112 may order the set of options based on a type of input accepted by the initial input interface. For example, for input interfaces that accept alphanumeric text, SOC 112 may order the set of options based on options that be more likely to improve the rate and/or accuracy in which input can be entered. For example, SOC 112 may order the set of options to include text-editing functions first as text-editing functions may be most helpful to the user (e.g., to the location of the text-editing function on the initial input interface if present) and reduce the quantity of button actuations by the user when providing input.

Alternatively, or additionally, SOC 112 may order the set of options using a machine-learning model or other predictive algorithm (e.g., such as a predictive text algorithm, etc.). The machine-learning model or other predictive algorithm may use historical input from the user, the current input provided to the initial input interface, and/or the like to generate a prediction of what the next character, number, or text-editing function will be or the likelihood, for each option, that the option will be selected next. SOC 112 may then order set of options based on the predictions such that the options with a higher likelihood of being selected next may appear before other options. In some instances, the machine-learning model or other predictive algorithm may predict the remaining portion of the word or phrase the user intends to input. In those instances, SOC 112 may define new options that correspond to the predicted input (e.g., the portion of the input already provided to the initial input interface by the user and the predicted remaining portion of the input), which may be included in the set of options before other options of the set of options.

SOC 112 may then define the context-based input interface by selecting one or more options from the set of options based on the order of the set of options. Each context-based input interface may be different based on variations of the context when the context-based input interface is generated. Alternatively, SOC 112 may include one or more predefined context-based input interfaces that are static and based on a type associated with the initial input interface. For example, a first context-based input interface including a first one or more options may be defined for an initial input interface configured for receiving a username and password. A second context-based input interface including a second (same or different) one or more options may be defined for an initial input interface configured for receiving search query).

A context-based input interface may be defined and presented upon detecting a particular input from an input device. For example, a user may operate remote controller 134 by actuating and holding a button for a predetermined time interval. Once the time interval has elapsed, the context-based input interface may be presented with the one or more options determined by SOC 112. An option can be highlighted using one or more directional buttons or touch controls. The highlighted option can be selected by releasing the actuated button, actuating the same button a second time, actuating another button, and/or the like. SOC 112 may then use the selected option to modify the initial input interface by adding the input if the option corresponds to an input, executing a text-editing function if the selected option corresponds to a text-editing option, etc.

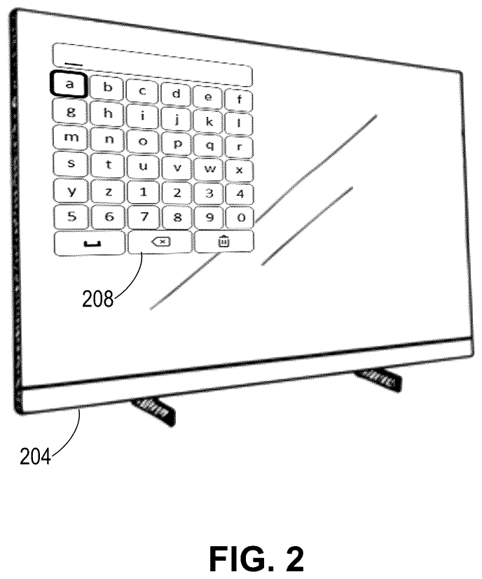

FIG. 2 illustrates an example representation of a digital keyboard interface on a television enabling alphanumeric input according to aspects of the present disclosure. Some devices may accept input from an input device that may lack controls for providing particular types of input. For example, television 204 may receive alphanumeric text as input to perform a query. Since remote controllers generally lack a full keyboard for providing alphanumeric input, television 204 may instead include digital keyboard interface 208. Digital keyboard interface 208 may include a representation of characters of an alphabet, the numbers 0-9, and one or more text-editing functions. Each character, number, and text-editing function may be represented as an element of digital keyboard interface 208. Digital keyboard interface 208 may be presented with a first element being highlighted representing a current location of digital keyboard interface 208. A user may use a remote controller with directional controls to navigate from a first element to a second element of digital keyboard interface 208. The user may operate the remote controller to select a particular element to add the character or number to the input (for elements representing characters or numbers) or execute the text-editing function (for elements representing text-editing functions). Digital keyboard interface 208 enables users to provide alphanumeric text via a remote controller that lacks buttons for each character and/or number expanding the capabilities of user interaction with television 204 while simplifying remote controllers.

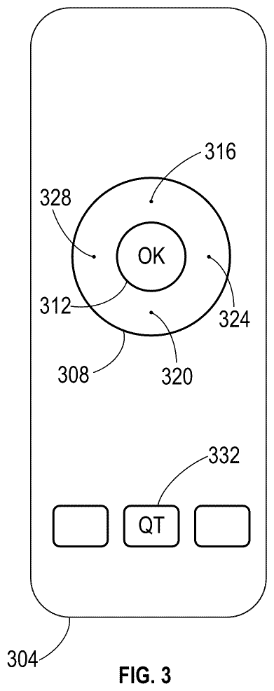

FIG. 3 illustrates an example physical interface of a remote controller of a media device according to aspects of the present disclosure. Remote controller 304 may include one or more buttons (e.g., 308-332) for providing input to a computing device associated with remote controller 304. Remote controller 304 include directional controls via circular element 308. Circular element 308 may include central button 312 that may be actuated to select an element that is currently highlighted within an input interface of the computing device. The portion of circular element 308 outside central button 312 may be actuated to provide directional input. For instance, upper portion 316 of circular element 308 may be interpreted as a command to navigate “up” relative to a current location of the input interface, lower portion 320 of circular element 308 may be interpreted as a command to navigate “down” relative to a current location of the input interface, right portion 324 of circular element 308 may be interpreted as a command to navigate “right” relative to a current location of the input interface, and left portion 328 of circular element 308 may be interpreted as a command to navigate “left” relative to a current location of the input interface. In some instances, circular element 308 may be actuated at any location such that actuating a position of circular element 308 between upper portion 316 and left portion 328 may be interpreted as a command to navigate “diagonally up and left” relative to a current location of the input interface.

In some instances, actuating central button 312 for a predetermined time interval (such as, for example, 1-2 seconds, may cause the computing device to generate a context-based interface that may modify the input interface and/or input currently received at the input interface. Alternatively, remote controller 304 may include a button dedicated to generating context-based interfaces (e.g., such that the button may not be usable to perform other functions). For example, remote controller may include button 332 configured to cause the computing device to generate a context-based interface.

In some instances, the input that may trigger generation of a context-based interface may be configurable by the computing device and/or the user. The computing device may include a list of buttons included in remote controller 304 and allow a user to select a button that will trigger generation of a context-based interface. The computing device may also receive input corresponding to a time interval over which the button is to be actuated to trigger generation of a context-based interface. The computing device may use a time interval if the selected button is useable to perform another function of the computing device to enable the computing device to distinguish between a button actuation intended to perform a function of the computing device from a button actuation intended to trigger generation of a context-based interface. The computing device may not define a time interval if the selected button is not associated with another function of the computing device. The input defining the time interval may be any value that is greater 1 second.

FIG. 4 illustrates an example digital keyboard interface according to aspects of the present disclosure. Digital keyboard interface 404 may be presented by a computing device (e.g., such as a television) to enable input of alphanumeric text from an input device that may lack specific controls of a keyboard. Digital keyboard interface 404 may include a set of elements with each element representing a character of an alphabet, a number, or a text-editing function (e.g., “backspace,” or “remove”, etc.). Each element may include an identification of the alphabet, a number, or a text-editing function represented by the element. Digital keyboard interface 404 may include an elongated input element 408 that presents the input received by digital keyboard interface 404.

Digital keyboard interface 404 may be generated with a first element being highlighted (e.g., by representing the element in bold, a different color, a larger size, etc.). Directional controls of a remote controller (e.g., such as remote controller 304 of FIG. 3) may be used to navigate digital keyboard interface 404. For example, the first element may be an element representing the character ‘a’. The remote controller may be operated by actuating a “down” portion of the directional control to cause digital keyboard interface 404 to highlight the element representing the character ‘g’, actuating a “right” portion of the directional control to cause digital keyboard interface 404 to highlight the element representing the character ‘b’, etc. Digital keyboard interface 404 may then stop highlighting the element representing the character ‘a’. Digital keyboard interface 404 may include wrapped navigation causing a navigating passed the boundary of the grid (e.g., moving left from the element representing the character ‘a’, where no element appears to the left of the element representing the character ‘a’) to highlight the element on the opposite side of the grid. For example, actuating an “up” portion of the directional control to cause digital keyboard interface 404 to highlight the element representing the character “space”, actuating a “left” portion of the directional control to cause digital keyboard interface 404 to highlight the element representing the character ‘f’.

The remote controller may be operated to select a highlighted element (e.g., by actuating central button 312 for example). Selecting a highlighted element may cause the character or number representing the element to appear in elongated input element 408. If the input appearing in elongated input element 408 is complete, then the remote controller may be operated to select an element indicating the input is complete causing the computing device to execute an operation using the input. For example, if digital keyboard interface 404 is generated to accept a search query, then indicating the input is complete may execute the search query using the input as an argument of the query. The operation that may be executed may be based on the interface that triggered the presentation of the digital keyboard interface.

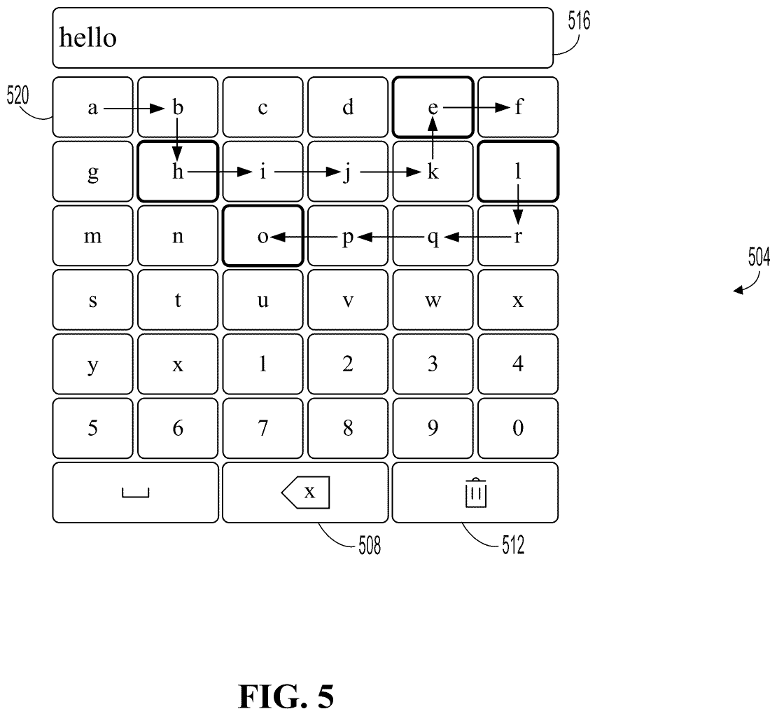

FIG. 5 illustrates an example of providing input through a digital keyboard interface according to aspects of the present disclosure. A user may operate a remote controller to provide alphanumeric input to an interface of a computing device using digital keyboard interface 504. The remote controller may include directional controls that may be actuated to navigate to particular elements and select the particular elements. If the intended input includes a large quantity of characters, providing the input may require the user to actuate the directional controls many times. The number of times the user may have to actuate the directional controls may be even greater if a mistake is made due to the distance that elements representing text-editing controls such as “backspace” 508 and “remove” 512 may be from the elements representing characters.

For example, a user may intend to enter “hello” into the elongated input element 516 by individually selecting the elements representing the characters ‘h’, ‘c’, ‘l’, and ‘o’. When digital keyboard interface 504 is generated, a first element may be highlighted indicating a starting position when selecting elements. In some instances, the starting position may be element 520 representing the character ‘a’. Arrows between elements indicate the direction of the directional controls that is actuated to move from one element to the next. The word “hello” may input with 17 buttons actuation of the remote controller. For example, to actuate the character ‘h’: a right portion of the directional controller may be actuated to highlight the element representing character ‘b’ followed by a down portion of the directional controller may be actuated to highlight the element representing character ‘h’ and an actuation of a select button (e.g., such as central button 312 of FIG. 3 or the like) to cause the character ‘h’ to be input to elongated input element 516.

If the user makes a mistake at any time, the user may navigate to elements representing text-editing controls such as “backspace” 508 and “remove” 512 which may increase the quantity of button actuations. For example, if the user selected the element representing the character ‘r’ by accident, the user may have to actuate the “down” portion of the directional control four times to highlight the element representing “remove” 512, the “left” portion of the directional control once to highlight the element representing “backspace” 508, and actuation of a select button implement the “backspace” to remove the last added character, the accidental ‘r’. The user may then have to actuate the directional controls multiple times highlight the next letter should be input.

A context-based input interface can be presented to provide customized input or text-editing functions at any location of the grid without requiring the user to navigate to the particular input or text-editing function. Returning to the previous example, when the user accidentally selects the element representing the character ‘r’, the user can actuate the “select” button for a predetermined time interval to display a context-based input interface that includes text-editing controls such as “backspace” 508. The user can then select “backspace” 508 to remove the accidental ‘r’ by de-actuating (e.g., releasing the pressure applied to) the “select” button when the “backspace” 508 is selected. The user can remove the accidental character ‘r’ with a single button actuation instead of the 5-10 button actuations needed to navigate to the element representing “backspace” 508 and back to the element representing characters intended to be input.

In some instances, the context-based input interface may include input that is predicted to follow the previous character or number that is input. For example, after selecting the element representing the letter ‘h’, the user may display the context-based input interface and the context-based input interface may include a representation of the letter ‘e’ allowing the user to input the letter e without actuating the buttons needed to highlight the element representing the letter ‘e’. In other instances, the context-based input interface may include a predicted word or phrase based on the previous character or number that is input (e.g., based media that is currently being presented on channels accessible to the computing device, historical words or phrases entered by the user, etc.). For example, after selecting the element representing the letter ‘h’, the user may display the context-based input interface and the context-based input interface may the word “hello” allowing the user to provide intended input without actuating the buttons needed to input the individual characters.

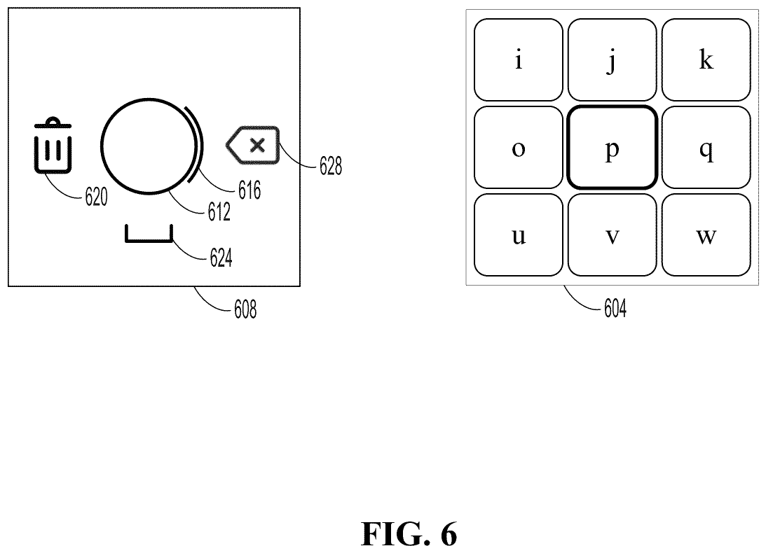

FIG. 6 illustrates an example transition from a digital keyboard interface to a context-based input interface according to aspects of the present disclosure. A user may cause a computing device may transition from digital keyboard interface 604 to context-based input interface 608. In some instances, the computing device may animate the switch from digital keyboard interface 604 to context-based input interface 608. For example, the start state of the animation may be presentation of the digital keyboard or a portion of the keyboard (e.g., as shown by digital keyboard interface 604) centering on a highlighted element. The highlighted element may begin as a substantially square shape. As the animation continues the element may transition into a circular shape (e.g., circular 612) and the surrounding elements may be deemphasized. For example, the other elements may fade into transparency (e.g., not visible), translucency (e.g., partially visible), reduced in size, moved away, changed in color, and/or the like. The animation may transform the highlighted element and the up to eight elements surround the highlighted elements into context-based input interface 608. In some instances, other elements of digital keyboard interface 604 may still be visible. In other instances, other elements of digital keyboard interface 604 may be in the background (e.g., reduced in size, transparent, translucent, etc.). The animation may be presented over a predetermined time interval to prevent delaying user interaction with the interface. For example, the animation may be presented over 400 milliseconds or less.

Context-based input interface 608 may include circle 612. A portion of the circle may be emphasized with a thicker outline or graphic 616 indicating the option adjacent to the emphasized portion is currently being highlighted. In some examples, the option that is most frequently selected by the user may be highlighted by default when context-based input interface 608 is presented to reduce the time needed to select the option that is likely to be selected by the user. In other examples, the option that was previously selected by the user may be highlighted by default when context-based input interface 608 is presented. For example, as shown graphic 616 is adjacent to option 628 indicating that option 628 is being highlighted. Context-based input interface 608 may include one or more options that can be selected by operation the directional controls of the input device. Selecting the “right” portion of the directional controls may move graphic 616 to highlight “remove” option 620, which may delete any input received by the elongated input element of digital keyboard interface 604. Selecting the “down” portion of the directional controls may move graphic 616 highlight “space” option 624, which may add a space character at the current location of a curser of the elongated input element of digital keyboard interface 604. Selecting the “right” portion of the directional controls may move graphic 616 highlight “backspace” option 628, which may remove the character to the left of the current location of a curser of the elongated input element of digital keyboard interface 604.

The directional controls of the input device may be operated to highlight an option (e.g., by moving graphic 616 to be positioned closest to the option intended to be highlighted, etc.) and selecting the option by actuating a select button (e.g., such as central button 312 of FIG. 3 or the like). Once selected, the computing device may modify the digital keyboard interface 604 by implementing the selected option. A second animation may be presented causing context-based input interface 608 to revert to digital keyboard interface 604. The second animation may be a reverse of the first animation. The second animation may be approximately the same length (e.g., 400 ms or less) as the first animation.

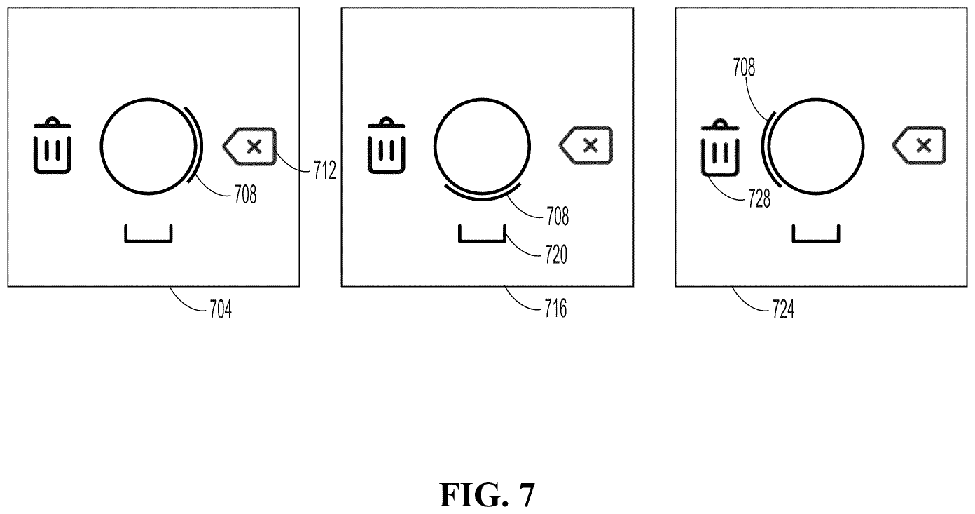

FIG. 7 illustrates an example navigation of a context-based input interface according to aspects of the present disclosure. Context-based input interface 704 may include one or more options based on a quantity of icons that that may be fit around the circular shape. In some instances, context-based input interface 704 may include four options for each of the primary directional controls (e.g., “up”, “down”, “left”, “right”, etc.). The emphasized portion of circular shape (illustrated as graphic 708) may be positioned based on the actuated portion of the directional controls. In some examples, since the directional controls can acuate any at any position along the circle represented by the circular shape (e.g., as shown by 308 of FIG. 3), the graphic 708 may appear at any portion of the circular shape actuated by directional controls. The position of graphic 708 may be updated in real time based on a corresponding change of the portion of the directional control being actuated.

The state of context-based input interface 704 shows “backspace” option 712 being highlighted based the portion of the circular shape adjacent to “backspace” option 712 being emphasized (e.g., shown as graphic 708). The state of context-based input interface 716 shows “space” character 720 being highlighted based the portion of the circular shape adjacent to “space” character 720 being emphasized (e.g., shown as graphic 708). The state of context-based input interface 724 shows “remove” option 728 being highlighted based the portion of the circular shape adjacent to “remove” option 728 being emphasized (e.g., shown as graphic 708). The user may cause the emphasized portion of the circular shape to change based on actuating a corresponding portion of the directional control of the input device. For instance, selecting the “right” portion of the directional controls may cause graphic 708 to move to highlight “remove” option 728, selecting the “down” portion of the directional controls may cause graphic 708 to move to highlight “space” character 720, and selecting the “right” portion of the directional controls may cause graphic 708 to move to highlight “backspace” option 712.

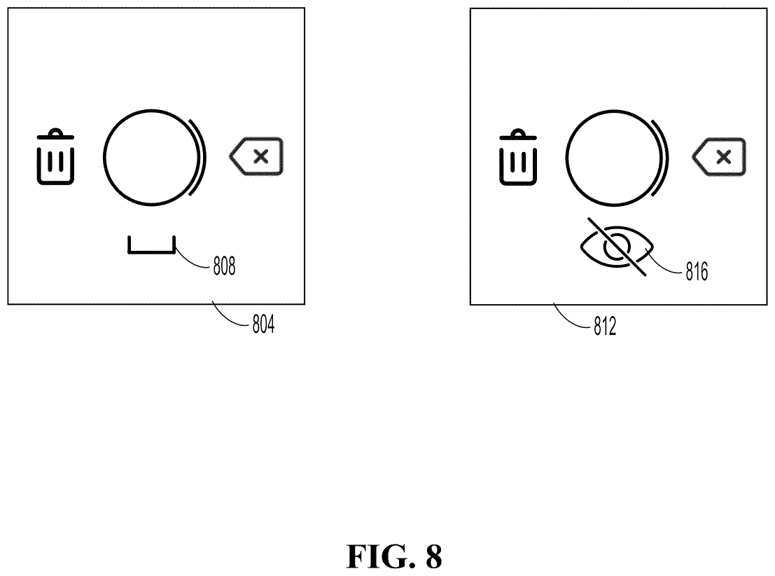

FIG. 8 illustrates an example context-based input interfaces according to aspects of the present disclosure. The computing device may define a context-based input interface based on the interface from which the context-based input interface is requested. For example, context-based input interface defined from an interface for entering a username and password may include different options than a context-based input interface defined from search query. As an illustrative example, context-based input interface 804 is an example context-based input interface defined from an input interface configured to receive alphanumeric text for a search query. Context-based input interface 804 may include “space” character 808 in addition to a “backspace” option and a “remove” option due to the frequency in which “space” character 808 and the “backspace” option and “remove” options are selected when providing input via a search query. Context-based input interface 812 is an example context-based input interface defined from an input interface configured to receive alphanumeric text for access credentials (e.g., username and password, network credentials such as a service set identifier (SSID) of a network and a corresponding password, password for parental controls, etc.). Context-based input interface 804 may include “view” option 816 (e.g., which may render the input visible or obfuscated) in addition to a “backspace” option and a “remove” option due to the frequency in which “view” option 816 as well as the “backspace” option and “remove” options are selected when providing access credentials.

The computing device selects options for context-based input interface to increase the rate and accuracy of providing input via a digital keyboard interface or other interface. The computing device may include options based on frequency of use and/or applicability to the interface from which the context-based input interface is defined. For example, context-based input interface 812 includes a “view” option because the “view” option is applicable to input that can be viewed or obfuscated (e.g., passwords, which are generally shown as dots or asterisks rather than the entered characters). Similarly, the computing device may exclude options that may not be relevant or that are rarely selected by the user. For example, when entering access credentials, the computing device may exclude options for particular characters that are rarely included in access credentials (e.g., such as “space”, etc.). Alternatively, or additionally, the computing device may exclude options associated with characters/symbols that the input interface does not allow in access credentials.

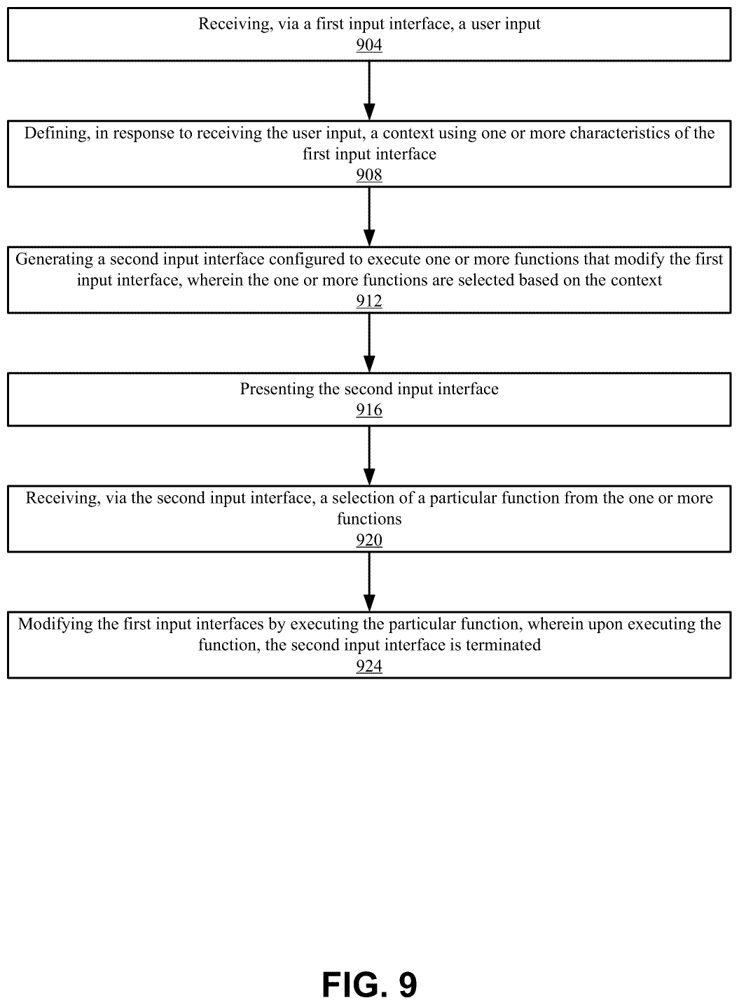

FIG. 9 illustrates a flowchart of an example process for generating context-based input interfaces according to aspects of the present disclosure. User input can be contextually controlled by two different input interfaces based on user interaction. For example, user input can be controlled by a first input interface configured to translate input into alphanumeric text based on user interaction and a second input interface (e.g., a context-based input interface) configured to provide context-based options that modify the user input and/or the first input interface.

At block 904, a computing device (e.g., a processing device that includes a display such as a television, etc.) may receive user input via a first input interface. The input may be received via an input device such as a mobile device, remote controller, or processing device in communication with the computing device. The first input interface may include a representation of particular input device enabling input from input devices that lack the buttons or other controls that may be included by the particular input device. For example, the first input interface may include a representation of a keyboard with each key of the keyboard being selectable using the input device to provide alphanumeric input. The first input interface may include a representation of any input devices such as, but not limited to, a keyboard, a keypad, joystick, touch interface, gamepad, or any other device configured to provide input. The input device may include one or more buttons that can be physically actuated or touch pads that can be manipulated by a user to provide input.

At block 908, the computing device may define a context using one or more characteristics of the first input interface in response to receiving the user input. A context may be a representation of a state of the first input interface, the computing device, and/or the user operating the computing device. For example, the current state of the first input interface may include, but is not limited to, an identification of the first input interface, an identification of an input type accepted by the first input interface (e.g., characters; numbers; alphanumeric text; particular text such as a username, password, email address, title, code, address; etc.; images; audio segments; video; etc.), an input already received by the first input interface since the first input interface was presented, a location of a cursor relative to the first input interface, a current button or control of the first input interface that is highlighted, an identification of what triggered the generation of the first input interface (e.g., how the first input interface was selected, what was being presented by the computing device when the first input interface was selected for generation, etc.), combinations thereof, or the like.

The current state of the computing device may include, but is not limited to, an identification of the processing capabilities of the computing device (e.g., available processing resources, network resources, etc.), network information such as an Internet Protocol (IP) address, Media Access Control (MAC) address, etc.), an identification of media that is available for presentation by the computing device (e.g., an identification of content that is currently being presented on channels accessible to the computing device), an identification of media that can be presented by the computing device (e.g., text, audio, and/or video; file types that can be presented; video resolutions that are supported; combinations thereof, or the like), media presented by the computing device when the first input interface was generated, an interface from which the first input interface was generated, devices connected to the computing device such as streaming devices or game consoles, combinations thereof, or the like. The current state of the user may include, but is not limited to, an identification of the user, historical interactions with the computing device (e.g., search history, media viewed, channels viewed, etc.), historical interactions with devices connected to the computing device, combinations thereof, or the like.

At block 912, the computing device may generate a second input interface. The second input interface may be generated in response the user input received via the first input interface at block 904. In some instances, the user input may correspond to actuating a button, actuating a button for a predetermined time interval (e.g., pressing a button down for the predetermined time interval such as 1-2 seconds, etc.), pressing a sequence of buttons, etc.). In other instances, the second input interface may be generated based on the context (e.g., the current location of the cursor or selected button or control of the first input interface, a current input of the first input interface, etc.). The second input interface may include an identification of one or more functions that can be selected using the input device via the second input interface. The one or more functions may be executed to modify the first input interface. The one or more functions may be selected based on the context. In some examples, the one or more functions may be text-editing functions configured to add and/or remove a current input provided to the first input interface such as, but not limited to, “backspace”, “delete”, “remove”, “view”, “space”, and/or the like. In some examples, the one or more functions may provide an input to the current input provided to the first input interface such as a symbol, character, number, or the like that is distant from a currently selected button or control of the first input interface. In some examples, the one or more functions may modify elements presented by the first input interface (e.g., adding or removing elements frequently accessed by the user, etc.) and/or an appearance of the first input interface (e.g., such as changing colors, opacity, etc.).

The one or more functions included in the second input interface may be selected based on the context to generate a customized second input interface for a user that may increase a rate and/or accuracy in which input can be provided to the first input interface. The one or more functions may be selected based on, for example, a previous interface from which the first input interface was generated, a current input to the first input interface (e.g., input provided by the input device, etc.), a location of a cursor or a currently selected button or control of the first input interface when the second input interface was generated, a frequency in which particular input or text-editing functions are selected by the user, historical input provided by the user after the input that has already been provided to the first input interface, etc.

In some instances, the computing device may execute a machine-learning model to select the one or more functions. The machine-learning model may be a configured to predict one or more functions that are likely to be selected by the user based on the context. The machine-learning model may also be configured to output a confidence score for each prediction indicative of the likelihood that the user will select that function. Examples of machine-learning models that may be trained to predict the one or more functions include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), statistical classifiers (e.g., Naïve Bayes, logistic regression models, perceptrons, support vector machine, random forest models, linear discriminant analyses models, k-nearest neighbor, boosting, combinations thereof, and/or the like), combinations thereof, or the like.

The machine-learning model may be trained using training data including historical interactions with the input interface, a current state of input interface when the contextual interface is activated, and/or any of the other forementioned contextual information. In some examples, the training data may be associated with a particular to tailor the trained machine-learning model to the particular user. In other examples, the training data may be associated with a particular class of users (e.g., users sharing one or more characteristics such as demographic information, interests, etc.) to tailor the trained machine-learning model to the particular class of users. In other instances, training data may be associated with general users. In other examples, the training data may initially be associated with general users when there is insufficient training data associated with the particular user or the particular class of users. As more training data associated with the particular user or the particular class of users is recorded, the machine-learning model may be retrained using the training data associated with the particular user or the particular class of users. As a result, the machine-learning model may be initially trained for general users and become tailored to the particular user or the particular class of users over time.

The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

At block 916, the computing device may present the second input interface. The second input interface may be presented over the first input interface, next to the first input interface (e.g., at any position that is on the same screen as the first input interface), in place of the first input interface, or the like. For example, the first input interface may be become deemphasized (e.g., placed in the background, minimized, reduced in size, presented as transparent or translucent, rendered in different colors, combinations thereof, or the like) and the second input interface may be presented over the first input interface. Alternatively, an animation may be presented transitions the first interface or the portion of the first interface that is highlighted into the second input interface.

In some instance, the second input interface may include a circle representing directional controls of the input device with icons represent the one or more functions positioned around the circle. The input device may be operated to highlight a function of the one or more functions. One or more buttons or a touch interface of the input device may be operated to select a particular function. The representation of the second input interface may be based on the first input interface and/or the quantity of functions of the one or more functions. For instance, if the one or more functions include eight or fewer functions, then the second input interface may include circular representing the directional controls of the input device. If the one or more functions include more than eight functions, then the second input interface may include a different representation such as a grid, or other representation in which the input device may be operated to select a function of the one or more functions with a single interaction with the input device.

At block 920, the computing device may receive a selection of a particular function from the one or more functions via the second input interface. The selection may be performed by actuating a button or operating a touch interface of the input device. If the second input interface is generated based on actuating a button of the input device for a predetermined time interval, the function may be highlighted while the button is actuated (e.g., the button is be depressed) and selected by de-actuating the button (e.g., removing pressure from the button).

The second input interface may be terminated upon selection of the function. Alternatively, the second input interface may be terminated upon execution of the selected function. Upon termination of the second input interface, the computing device may return to the first input interface (if not already shown) or return the first input interface to prominence (if deemphasized in favor of the second input interface). In some examples, an animation may be presented that is a reverse of the animation presented to present the second input interface.

At block 924, the computing device may modify the first input interface by executing the particular function. The input device may be operated to generate a new second input interface. Since the context may have changed since the previous generation of the second input interface, the new second input interface may include a different representation and/or different one or more functions that may be selected by the input device.

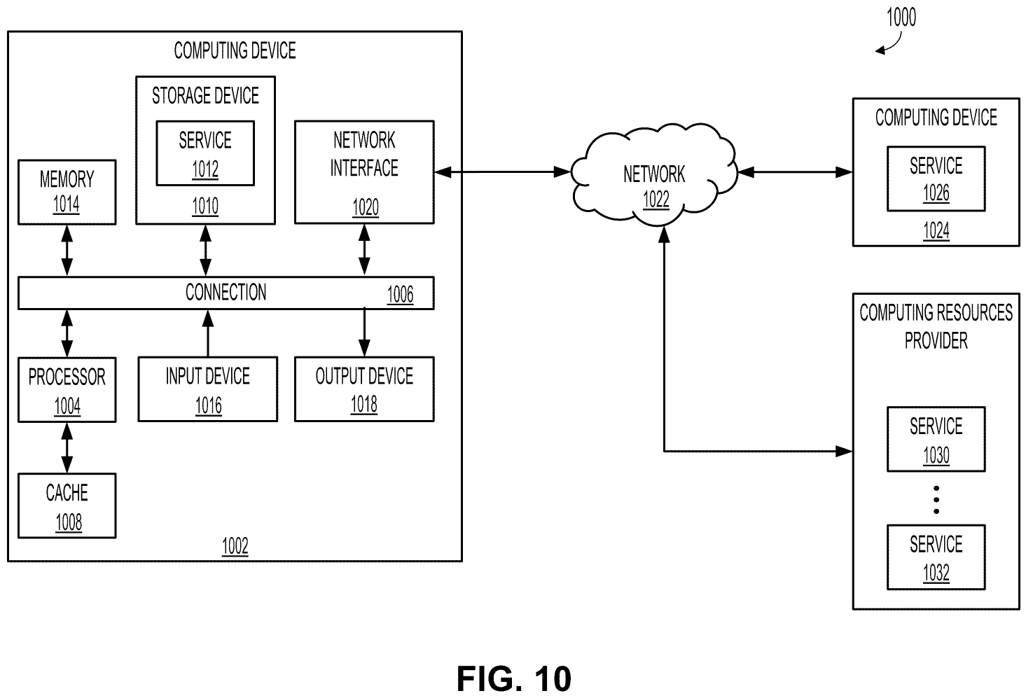

FIG. 10 illustrates an example computing device architecture of an example computing device that can implement the various techniques described herein according to aspects of the present disclosure. The example computing system architecture 1000 illustrated in FIG. 10 includes a computing device 1002, which has various components in electrical communication with each other using a connection 1006, such as a bus, in accordance with some implementations. The example computing system architecture 1000 includes a processing unit 1004 that is in electrical communication with various system components, using the connection 1006, and including the system memory 1014. In some embodiments, the system memory 1014 includes read-only memory (ROM), random-access memory (RAM), and other such memory technologies including, but not limited to, those described herein. In some embodiments, the example computing system architecture 1000 includes a cache 1008 of high-speed memory connected directly with, in close proximity to, or integrated as part of the processor 1004. The system architecture 1000 can copy data from the memory 1014 and/or the storage device 1010 to the cache 1008 for quick access by the processor 1004. In this way, the cache 1008 can provide a performance boost that decreases or eliminates processor delays in the processor 1004 due to waiting for data. Using modules, methods and services such as those described herein, the processor 1004 can be configured to perform various actions. In some embodiments, the cache 1008 may include multiple types of cache including, for example, level one (L1) and level two (L2) cache. The memory 1014 may be referred to herein as system memory or computer system memory. The memory 1014 may include, at various times, elements of an operating system, one or more applications, data associated with the operating system or the one or more applications, or other such data associated with the computing device 1002.

Other system memory 1014 can be available for use as well. The memory 1014 can include multiple different types of memory with different performance characteristics. The processor 1004 can include any general-purpose processor and one or more hardware or software services, such as service 1012 stored in storage device 1010, configured to control the processor 1004 as well as a special-purpose processor where software instructions are incorporated into the actual processor design. The processor 1004 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1004 can be a microprocessor, a microcontroller, a digital signal processor (“DSP”), or a combination of these and/or other types of processors. In some embodiments, the processor 1004 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1000, an input device 1016 can represent any number of input mechanisms, such as a microphone for speech, a touch-sensitive screen for gesture or graphical input, keyboard, mouse, motion input, pen, and other such input devices. An output device 1018 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1000. In some embodiments, the input device 1016 and/or the output device 1018 can be coupled to the computing device 1002 using a remote connection device such as, for example, a communication interface such as the network interface 1020 described herein. In such embodiments, the communication interface can govern and manage the input and output received from the attached input device 1016 and/or output device 1018. As may be contemplated, there is no restriction on operating on any particular hardware arrangement and accordingly the basic features here may easily be substituted for other hardware, software, or firmware arrangements as they are developed.

In some embodiments, the storage device 1010 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1010 can include hardware and/or software services such as service 1012 that can control or configure the processor 1004 to perform one or more functions including, but not limited to, the methods, processes, functions, systems, and services described herein in various embodiments. In some embodiments, the hardware or software services can be implemented as modules. As illustrated in example computing system architecture 1000, the storage device 1010 can be connected to other parts of the computing device 1002 using the system connection 1006. In some embodiments, a hardware service or hardware module such as service 1012, that performs a function can include a software component stored in a non-transitory computer-readable medium that, in connection with the necessary hardware components, such as the processor 1004, connection 1006, cache 1008, storage device 1010, memory 1014, input device 1016, output device 1018, and so forth, can carry out the functions such as those described herein.

The disclosed systems and services can be performed using a computing system such as the example computing system illustrated in FIG. 10, using one or more components of the example computing system architecture 1000. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the media device described herein by, for example, executing code using a processor such as processor 1004 wherein the code is stored in memory such as memory 1014 as described herein. One or more of a user device, a provider server or system, a database system, or other such devices, services, or systems may include some or all of the components of the computing system such as the example computing system illustrated in FIG. 10, using one or more components of the example computing system architecture 1000 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1028. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1004 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1014 can be coupled to the processor 1004 by, for example, a connector such as connector 1006, or a bus. As used herein, a connector or bus such as connector 1006 is a communications system that transfers data between components within the computing device 1002 and may, in some embodiments, be used to transfer data between computing devices. The connector 1006 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1014 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1014 can also include magnetic or optical data storage media including read-only (e.g., CD ROM and DVD ROM) or otherwise (e.g., CD or DVD). The memory can be local, remote, or distributed.

As described above, the connector 1006 (or bus) can also couple the processor 1004 to the storage device 1010, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1010. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1006 can also couple the processor 1004 to a network interface device such as the network interface 1020. The interface can include one or more of a modem or other such network interfaces including, but not limited to those described herein. It will be appreciated that the network interface 1020 may be considered to be part of the computing device 1002 or may be separate from the computing device 1002. The network interface 1020 can include one or more of an analog modem, Integrated Services Digital Network (ISDN) modem, cable modem, token ring interface, satellite transmission interface, or other interfaces for coupling a computer system to other computer systems. In some embodiments, the network interface 1020 can include one or more input and/or output (I/O) devices. The I/O devices can include, by way of example but not limitation, input devices such as input device 1016 and/or output devices such as output device 1018. For example, the network interface 1020 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1002 can be connected to one or more additional computing devices such as computing device 1024 via a network 1022 using a connection such as the network interface 1020. In such embodiments, the computing device 1024 may execute one or more services 1026 to perform one or more functions under the control of, or on behalf of, programs and/or services operating on computing device 1002. In some embodiments, a computing device such as computing device 1024 may include one or more of the types of components as described in connection with computing device 1002 including, but not limited to, a processor such as processor 1004, a connection such as connection 1006, a cache such as cache 1008, a storage device such as storage device 1010, memory such as memory 1014, an input device such as input device 1016, and an output device such as output device 1018. In such embodiments, the computing device 1024 can carry out the functions such as those described herein in connection with computing device 1002. In some embodiments, the computing device 1002 can be connected to a plurality of computing devices such as computing device 1024, each of which may also be connected to a plurality of computing devices such as computing device 1024. Such an embodiment may be referred to herein as a distributed computing environment.

The network 1022 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1022 can be wired connections, wireless connections, or combinations thereof. Communications via the network 1022 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1022, within the computing device 1002, within the computing device 1024, or within the computing resources provider 1028 can include information, which also may be referred to herein as content. The information may include text, graphics, audio, video, haptics, and/or any other information that can be provided to a user of the computing device such as the computing device 1002. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1002 and presented to a user of the computing device 1002 using forms that are perceptible via sight, sound, smell, taste, touch, or other such mechanisms. In some embodiments, communications over the network 1022 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1002 and/or the computing device 1024 can be connected to a computing resources provider 1028 via the network 1022 using a network interface such as those described herein (e.g., network interface 1020). In such embodiments, one or more systems (e.g., service 1030 and service 1032) hosted within the computing resources provider 1028 (also referred to herein as within “a computing resources provider environment”) may execute one or more services to perform one or more functions under the control of, or on behalf of, programs and/or services operating on computing device 1002 and/or computing device 1024. Systems such as service 1030 and service 1032 may include one or more computing devices such as those described herein to execute computer code to perform the one or more functions under the control of, or on behalf of, programs and/or services operating on computing device 1002 and/or computing device 1024.

For example, the computing resources provider 1028 may provide a service, operating on service 1030 to store data for the computing device 1002 when, for example, the amount of data that the computing device 1002 exceeds the capacity of storage device 1010. In another example, the computing resources provider 1028 may provide a service to first instantiate a virtual machine (VM) on service 1032, use that VM to access the data stored on service 1032, perform one or more operations on that data, and provide a result of those one or more operations to the computing device 1002. Such operations (e.g., data storage and VM instantiation) may be referred to herein as operating “in the cloud,” “within a cloud computing environment,” or “within a hosted virtual machine environment,” and the computing resources provider 1028 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1028 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1030 and service 1032 may implement versions of various services (e.g., the service 1012 or the service 1026) on behalf of, or under the control of, computing device 1002 and/or computing device 1024. Such implemented versions of various services may involve one or more virtualization techniques so that, for example, it may appear to a user of computing device 1002 that the service 1012 is executing on the computing device 1002 when the service is executing on, for example, service 1030. As may also be contemplated, the various services operating within the computing resources provider 1028 environment may be distributed among various systems within the environment as well as partially distributed onto computing device 1024 and/or computing device 1002.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

As used below, any reference to a series of examples is to be understood as a reference to each of those examples disjunctively (e.g., “Examples 1-4” is to be understood as “Examples 1, 2, 3, or 4”).

Example 1 is a method comprising: receiving, via a first input interface, a user input; defining, in response to receiving the user input, a context using one or more characteristics of the first input interface; generating a second input interface configured to execute one or more functions that modify the first input interface, wherein the one or more functions are selected based on the context; presenting the second input interface; receiving, via the second input interface, a selection of a particular function from the one or more functions; and modifying the first input interface by executing the particular function, wherein upon executing the particular function, the second input interface is terminated.

Example 2 is the method of any of example(s) 1 and 3-12, wherein the second input interface is presented in place of the first input interface.

Example 3 is the method of any of example(s) 1-2 and 4-12, wherein the second input interface is presented on top of the first input interface.

Example 4 is the method of any of example(s) 1-3 and 5-12, wherein the first input interface is a digital keyboard.

Example 5 is the method of any of example(s) 1-4 and 6-12, wherein the user input corresponds to a timed activation of a button of a remote control.

Example 6 is the method of any of example(s) 1-5 and 7-12, wherein a characteristic of the one or more characteristics includes a portion of a password being entered via the first input interface, and wherein the particular function displays the portion of a password.

Example 7 is the method of any of example(s) 1-6 and 8-12, wherein a characteristic of the one or more characteristics identifies a portion of the first input interface that is highlighted, and wherein the particular function highlights a different portion of the first input interface.

Example 8 is the method of any of example(s) 1-7 and 9-12, wherein a characteristic of the one or more characteristics identifies a portion of the first input interface that is selectable, and wherein the particular function selects the portion of the first input interface that is selectable.

Example 9 is the method of any of example(s) 1-8 and 10-12, wherein a characteristic of the one or more characteristics identifies one or more characters that have been input into the first input interface, and wherein the particular function modifies the one or more characters.

Example 10 is the method of any of example(s) 1-9 and 11-12, wherein executing the particular function deletes one or more characters.

Example 11 is the method of any of example(s) 1-10 and 12, wherein executing the particular function cuts one or more characters.

Example 12 is the method of any of example(s) 1-11, wherein executing the particular function replaces the one or more characters with one or more other characters.

Example 13 is a system comprising: one or more processors; a non-transitory computer-readable medium storing instructions that when executed by the one or more processors, cause the one or more processors to perform the methods of any of example(s) s 1-12.

Example 14 is a non-transitory computer-readable medium storing instructions that when executed by one or more processors, cause the one or more processors to perform the methods of any of example(s) s 1-12.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hercon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving, via a first input interface, a user input;
defining, in response to receiving the user input, a context using one or more characteristics of the first input interface;
generating a second input interface configured to execute one or more functions that modify the first input interface, wherein the one or more functions are selected based on the context;
presenting the second input interface;
receiving, via the second input interface, a selection of a particular function from the one or more functions; and
modifying the first input interface by executing the particular function, wherein upon executing the particular function, the second input interface is terminated.

2. The method of claim 1, wherein the second input interface is presented in place of the first input interface.

3. The method of claim 1, wherein the second input interface is presented on top of the first input interface.

4. The method of claim 1, wherein the user input corresponds to a timed activation of a button of a remote control.

5. The method of claim 1, wherein a characteristic of the one or more characteristics includes a portion of a password being entered via the first input interface, and wherein the particular function displays the portion of a password.

6. The method of claim 1, wherein a characteristic of the one or more characteristics identifies a portion of the first input interface that is highlighted, and wherein the particular function highlights a different portion of the first input interface.

7. The method of claim 1, wherein a characteristic of the one or more characteristics identifies a portion of the first input interface that is selectable, and wherein the particular function selects the portion of the first input interface that is selectable.

8. A system comprising:
one or more processors; and
a non-transitory computer-readable medium storing instructions that when executed by the one or more processors, cause the one or more processors to perform operations including:
receiving, via a first input interface, a user input;
defining, in response to receiving the user input, a context using one or more characteristics of the first input interface;
generating a second input interface configured to execute one or more functions that modify the first input interface, wherein the one or more functions are selected based on the context;
presenting the second input interface;
receiving, via the second input interface, a selection of a particular function from the one or more functions; and
modifying the first input interface by executing the particular function, wherein upon executing the particular function, the second input interface is terminated.

9. The system of claim 8, wherein the second input interface is presented in place of the first input interface.

10. The system of claim 8, wherein the second input interface is presented on top of the first input interface.

11. The system of claim 8, wherein the user input corresponds to a timed activation of a button of a remote control.

12. The system of claim 8, wherein a characteristic of the one or more characteristics includes a portion of a password being entered via the first input interface, and wherein the particular function displays the portion of a password.

13. The system of claim 8, wherein a characteristic of the one or more characteristics identifies a portion of the first input interface that is highlighted, and wherein the particular function highlights a different portion of the first input interface.

14. The system of claim 8, wherein a characteristic of the one or more characteristics identifies a portion of the first input interface that is selectable, and wherein the particular function selects the portion of the first input interface that is selectable.

15. A non-transitory computer-readable medium storing instructions that when executed by one or more processors, cause the one or more processors to perform operations including:
receiving, via a first input interface, a user input;
defining, in response to receiving the user input, a context using one or more characteristics of the first input interface;
generating a second input interface configured to execute one or more functions that modify the first input interface, wherein the one or more functions are selected based on the context;
presenting the second input interface;
receiving, via the second input interface, a selection of a particular function from the one or more functions; and
modifying the first input interface by executing the particular function, wherein upon executing the particular function, the second input interface is terminated.

16. The non-transitory computer-readable medium of claim 15, wherein the second input interface is presented in place of the first input interface.

17. The non-transitory computer-readable medium of claim 15, wherein the second input interface is presented on top of the first input interface.

18. The non-transitory computer-readable medium of claim 15, wherein the user input corresponds to a timed activation of a button of a remote control.

19. The non-transitory computer-readable medium of claim 15, wherein a characteristic of the one or more characteristics includes a portion of a password being entered via the first input interface, and wherein the particular function displays the portion of a password.

20. The non-transitory computer-readable medium of claim 15, wherein a characteristic of the one or more characteristics identifies a portion of the first input interface that is highlighted, and wherein the particular function highlights a different portion of the first input interface.
